(19) United States
(12) Patent Application Publication
(10) Pub. No.: US 2003/0002127 A1
(43) Pub. Date: Jan. 2, 2003

(54) Polarisation beam splitters/combiners

(76) Inventor: David Simon George, London (GB)

Correspondence Address: Mark D Saralino, Renner Otto Boisselle & Sklar, 19th Floor, 1621 Euclid Avenue, Cleveland, OH, 44115, US

(21) Appl. No.: 10/169,623

(22) PCT Filed: Oct. 26, 2001
(86) PCT No.: PCT/GB01/04753

(30) Foreign Application Priority Data
Oct. 28, 2000 (GB) 0026415.0

(51) Int. Cl. G02B 6/00; G02B 6/26; G02B 6/42; G02F 1/03; G02F 1/07

(52) U.S. Cl. 359/246; 385/11; 385/27; 385/30

(57) ABSTRACT

A polarization beam splitter comprises a substrate, two waveguides formed in the substrate for conducting different polarization components, and an evanescent coupler acting between the waveguides to split an input light signal incorporating TE and TM polarization components into an output signal consisting of the TE polarization component and an light output signal consisting of the TM polarization component conducted along respective waveguides. To this end the evanescent coupler comprises substantially identical adjacent portions of the two waveguides arranged symmetrically with respect to one another and having geometries such that one of the polarization components extends laterally within each waveguide portion to a greater extent than the other polarization component. The splitting apart of the two polarization components occurs due to the resulting difference between the coupling length for said one polarization component and the coupling length for said other polarization component. If the coupling length for one of the polarization components is an integral multiple of the coupling length for the other polarization component, then the two components TE and TM will be completely split between the two waveguides, although there may be some applications in which only a proportion of one of the components is to be split off from the remainder of the input light. Such an arrangement, which may also be applied to a combiner, is advantageous since it enables the device to be totally integrated and does not require any metallization.

The present invention relates to polarisation beam splitters and combiners, and is concerned more particularly, but not exclusively, with such splitters and combiners for use in optical communication systems.

### BACKGROUND OF THE INVENTION

Optical fibre communication systems and optical fibre based devices require coupling of optical fibres with integrated optical devices. However a particular problem arises due to the fact that, after transmission through an optical fibre, the state of polarisation of a light beam is unpredictable due to the random nature of the birefringence arising from fibre non-circularity, bending, stress and other inhomogeneities. Furthermore the losses incurred in most optical components are dependent on polarisation. As a result, the power of the received light in an optical fibre communication system will depend on the polarisation dependent losses (PDL) of the optical components of the system, and such losses can accumulate considerably for a large system. In simple intensity modulation for instance, the received power for the one polarisation state may be vastly different from that for another. The same problems could arise for coherent systems in which a receiver mixes the incoming signal with a local oscillator signal. In this case fading will occur if the incoming polarisations are not matched to the local oscillator signals. Furthermore if the data is encoded by polarisation modulation, the variation of the polarisation state by the transmission medium may lead to cross-talk at the receiver.

In addition the state of polarisation and the PDL may vary in time, and will generally be different for each link in a network. Consequently it is impossible to calibrate the system with a single reference signal. For incoherent systems it may be possible to use depolarised light, however, this is impractical since the signal would quickly pick up a degree of polarisation as it propagated through the various components. Accordingly it would seem that the only possibility to minimise such differential losses is to ensure that each component has substantially zero PDL so that the received power will be substantially constant as the polarisation changes.

Polarisation dependent loss (PDL) is the part of the total loss that changes as the polarisation is varied over all possible states. In general, the PDL is defined as the maximum loss for the component minus the minimum loss for the component, as the polarisation is varied over all possible states. For an integrated optical waveguide device, the modes are often of a quasi-linear polarisation state, either Transverse Electric (TE) or Transverse Magnetic (TM). For the TE mode the electric field lies predominantly in the transverse plane, whereas for the TM mode the magnetic field lies predominantly in the transverse plane, so the electric field lies in the vertical plane. Since these modes usually have the minimum and maximum losses the PDL may be defined as the TE loss minus the TM loss.

Various known splitters or combiners are disclosed in GB 2315880A, EP 0465425A1, EP 0350110A1, U.S. Pat. No. 5,946,434, U.S. Pat. No. 4,772,084 and JP 090127347A. However each of these prior arrangements requires specially adapted differential structuring of the waveguides, such as differential sizing or metallisation for example, in order to effect the required splitting.

It is an object of the invention to provide a polarisation beam splitter/coupler which can be produced in a particularly straightforward manner.

### SUMMARY OF THE INVENTION

According to one aspect of the present invention there is provided a polarisation beam splitter/combiner comprising a substrate, two waveguides formed on the substrate for conducting two different polarisation components, and an evanescent coupler acting between the waveguides to split apart or combine together the two polarisation components conducted along the waveguides, wherein the evanescent coupler comprises substantially identical adjacent portions of the two waveguides arranged symmetrically with respect to one another and having geometries such that one of the polarisation components extends laterally within each waveguide portion to a greater extent than the other polarisation component and the coupling length for one of the polarisation components is an even multiple of the coupling length for the other polarisation component, so that substantially complete splitting apart or combining together of the two polarisation components occurs due to the resulting difference between the coupling length for said one polarisation component and the coupling length for said other polarisation component.

In this context the “coupling length” is defined as the path length required for the relevant polarisation component (or mode) to transfer completely from one waveguide to the other waveguide and back again. The coupling lengths will be different for the different polarisation components, such as the TE and TM components, because of the different mode shapes and heights within the waveguides. The coupling lengths will also be dependent on the dimensions of the waveguides and their separations, and the ratio of the coupling length for one polarisation component to the coupling length for the other polarisation component, which is preferably an integral multiple, may be changed by varying these parameters. In order for complete splitting to be achieved one coupling length should be an even integral multiple of the other coupling length. These coupling lengths are not to be confused with the actual length of the evanescent coupler which can be an odd integral multiple of the shorter coupling length where complete splitting is required, but which may be any length provided that it is of sufficient length to accommodate the required degree of splitting of the polarisation components.

Such a device possesses a number of advantages over other types of splitter/combiner in that the device can be totally integrated, requires no metallisation (although metallisation may be provided in certain embodiments) and is totally passive. Furthermore the device may easily form part of a photonic integrated circuit.

The polarisation components will be completely separated from one another or combined together if there is an integral multiple relationship between the coupling lengths. On the other hand, the splitting will be incomplete if the coupling lengths are not related to one another by an integral multiple, as may be required, for example, if only a proportion of one of the components is to be split off from the remainder of the input signal.

A polarisation splitter/combiner has many uses in optical systems, in particular in schemes for reducing polarisation sensitivity and in schemes for routing signals.

To reduce sensitivity, for example, in order to achieve polarisation commonality, a device in accordance with the invention may be designed to split an input signal into two polarisation components. One component may then be rotated into the same state as the other component using a polarisation rotator. The two identical polarisation components may then be supplied together to the polarisation sensitive system. A similar device in accordance with the invention may be used in polarisation diversity receivers for coherent communications, whereby the two components are split, and mixed separately with orthogonal local oscillators. Furthermore a device in accordance with the invention may be used in a digital communication system in which 0 is denoted by one polarisation state and 1 by the other, in order to reduce sensitivity to variation in polarisation due to propagation which would otherwise lead to cross-talk.

Additionally devices in accordance with the invention may be used as switching devices. By using a splitter, the routing of the signal will be dependent on the polarisation. This may be extended to active wavelength routers, for example electro-optic tunable filters and acousto-optic tunable filters using polarisation splitters and converters which are wavelength sensitive. In the context of wavelength division multiplexed systems, it may be advantageous to launch adjacent channels with cross polarisations to reduce non-linear beating effects. Polarisation splitters could be used in such systems for demultiplexing.

According to another aspect of the present invention there is provided a polarisation dependent loss (PDL) compensator comprising a polarisation beam splitter for splitting an optical input signal into two polarisation components in two waveguides, and photodetector means aligned in relation to the waveguides to receive different proportions of the two polarisation components from the waveguides and to produce an electrical output signal indicative of the optical power of the input signal and substantially independent of the polarisation of the input signal.

According to another aspect of the present invention there is provided a polarisation controller comprising a polarisation beam splitter for splitting an input signal into two polarisation components in two waveguides (2, 3; 10, 11), means (14, 15) for applying different losses to the two polarisation components, and a polarisation beam combiner (13) for combining together the two polarisation components to produce an output signal incorporating the polarisation components or one of the polarisation components at the required power. Such a controller may utilise a splitter or combiner in accordance with the first aspect or some other type of splitter or combiner. Furthermore such a controller may serve as a PDL compensator if the applied losses are arranged to compensate for the PDL of the surrounding system to produce zero overall PDL.

According to a further aspect of the present invention there is provided a method of splitting apart or combining together two polarisation components comprising passing the polarisation components through two waveguides (2, 3; 10, 11) linked by an evanescent coupler (6; 12, 13), the evanescent coupler (6; 12, 13) comprising substantially identical adjacent portions of the two waveguides (2, 3; 10, 11) arranged symmetrically with respect to one another and having geometries such that one of the polarisation components extends laterally within each waveguide portion to a greater extent than the other polarisation component so that splitting apart or combining together of the two polarisation components occurs due to the resulting difference between the coupling length for said one polarisation component and the coupling length for said other polarisation component.

### BRIEF DESCRIPTION OF THE DRAWINGS

For a better understanding of the present invention and to show how the same may be carried into effect, reference will now be made, by way of example, to the accompanying drawings, in which:

FIG. 1 is a highly schematic explanatory diagram illustrating the principle behind the invention;

FIG. 2 is a cross-section taken along the line A-A in FIG. 1;

FIG. 3 shows variation of the field with distance within the waveguides for the TE polarisation and TM polarisation respectively; and

FIG. 4 is an explanatory diagram illustrating a development of the invention.

### DETAILED DESCRIPTION OF THE DRAWINGS

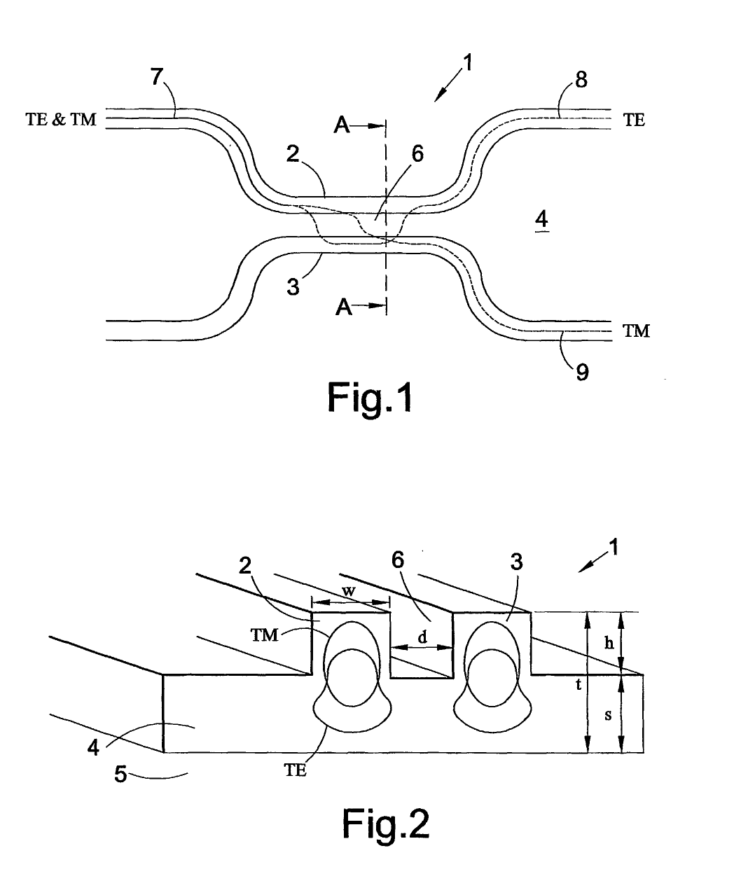

FIG. 1 shows an integrated polarisation beam splitter 1 in plan view comprising two identical waveguides 2 and 3 formed by etching in an epitaxial layer 4 on a substrate 5 (see FIG. 2). The waveguides 2 and 3 form an evanescent coupler 6 in a region in which they lie closely adjacent to one another.

Shown diagrammatically in FIG. 1 is an input light signal 7 travelling along the waveguide 2 and incorporating both TE and TM polarisation components. The TE mode couples into the other waveguide 3 more readily than the TM mode, and thus requires a shorter coupling length. As shown schematically in broken lines, due to the fact that the TE coupling length is half the TM coupling length, and in view of the overall length of the evanescent coupler 6, the TE field couples fully from the waveguide 2 to the waveguide 3 and then back again to the waveguide 2 within the coupler 6, whereas, in the same length, the TM field only couples from the first waveguide 2 to the second waveguide 3, with the result that the output light signal 8 conducted by the waveguide 2 comprises only the TE component whereas the output light signal 9 conducted by the waveguide 3 comprises only the TM component.

Referring to FIG. 2 the two waveguides 2 and 3 have the same dimensions, that is the width w, the etch depth h, the slab depth s and the total epitaxial layer thickness t=h+s. These dimensions, and the spacing d of the waveguides 2 and 3, determine the coupling lengths for the polarisation components TE and TM. Typically t is 2 μm, h is 1.17 μm, w is 1.4 μm and d is 0.6 to 1.0 μm for producing coupler lengths from 600 to 1,500 μm. Another design of splitter uses larger waveguides with t=9.3, h=6.7, and w=3.5. With a separation of the waveguides of 5-8 microns, a length of 10-30 mm is required to provide polarisation splitting. Absolute device dimensions are hard to specify, since the coupler birefringence depends on a number of factors. For a given waveguide spacing d, it is possible to specify an optimum coupling length.

Generally the device in accordance with the invention operates by utilising two waveguides coupled by a symmetrical evanescent coupler, with there being no physical differences between the waveguides in the vicinity of the coupler. There are usually only two possible polarisation states for the modes, that is TE and TM, and the device operates by ensuring that the coupling length for the TM mode is an integral multiple of the coupling length for the TE mode.

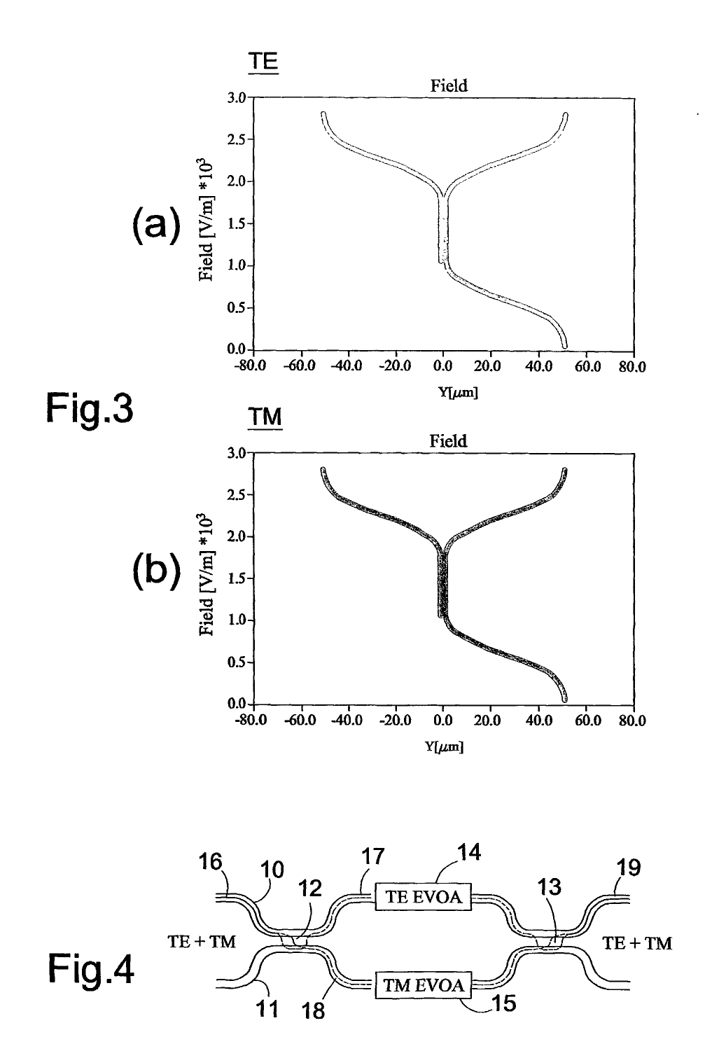

The optical power in the TE mode and the TM mode for a particular embodiment of the invention is shown by the graphs at (a) and (b) in FIG. 3 which show the field intensity plotted as a function of distance along the Y axis relative to the centre of the waveguide. As can be seen the TE coupling length is half the TM coupling length in this embodiment. Consequently the TE field couples fully from the first waveguide to the second waveguide in the coupler and back again into the first waveguide, whereas, in the same length, the TM field only couples from the first waveguide to the second waveguide. These results from a beam propagation method (BPM) package were supported by simulation of the supermodes of the two parallel waveguides at the centre of the coupler using a mode solver. The difference in effective indices for the lowest order even and odd super modes predicted a coupling length for the TE polarisation which is half that for the TM polarisation.

Of course the length of the evanescent coupler in a device in accordance with the invention can be increased so that the light signal makes multiple transits between the waveguides, for example so that the TE field couples from the first waveguide to the second waveguide, back to the first waveguide and then back to the second waveguide again, whereas, in the same length, the TM field couples from the first waveguide to the second waveguide and back again to the first waveguide, which is equivalent to three transits between the waveguides for the TE field and two transits between the waveguides for the TM field. Any number of transits for either of the two modes may be chosen to obtain the desired output signals. Furthermore the coupling between the waveguides may be chosen to obtain the desired ratio of TE to TM components in one or both of the output waveguides. Additionally the device may be used in the reverse manner to that described with reference to FIG. 1, that is as a combiner rather than a splitter, with two input signals supplied to the waveguides 2 and 3 being combined in the vicinity of the coupler 6 to provide one or more combined output signals in one or both of the waveguides 2 and 3.

It should be appreciated that the design of the waveguides and their distance apart is critical, as are the refractive indices, if sufficiently large birefringence is to be present to obtain the required widely differing coupling lengths for the TE and TM modes. This is quite different from the properties of conventional evanescent couplers in which it is required that the birefringence should be as low as possible. Generally higher order devices, that is those employing multiple transits, may be designed by providing a longer coupler and/or by positioning the waveguides closer together. In such a higher order device, although the overall length of the device may be greater than that of a first order device, the sensitivity to coupling length variations will be less.

FIG. 4 diagrammatically shows a development of the invention constituting an integrated polarisation dependent loss (PDL) compensator and controller which serves to compensate for PDL by separating the input light signal into two polarisation components, for example a TE polarisation component and a TM polarisation component, and by inducing more loss in one polarisation component than the other polarisation component before recombining the polarisation components to obtain the output light signal. In the arrangement of FIG. 4 two waveguides 10 and 11 are coupled by two evanescent couplers 12 and 13 and incorporate two electronic variable optical attenuators (EVOA's) 14 and 15 applying different amounts of loss to the TE and TM components.

In operation of such a device an input light signal 16 incorporating both TE and TM polarisation components is applied to the waveguide 10 and is split in the coupler 12 such that the TE component 17 continues in the waveguide 10 whereas the TM component 18 is switched from the waveguide 10 to the waveguide 11. The resulting TE and TM components 17 and 18 are attenuated to different extents by the EVOA's 14 and 15 before being recombined in the coupler 13 to obtain the output light signal 19. The relative degrees of attenuation of the EVOA's 14 and 15 are chosen such as to apply a compensating PDL which cancels the PDL of the rest of the system so that the total system has zero PDL. In other words the loss applied to the TE polarisation component added to the initial loss associated with the TE polarisation component will equal the loss applied to the TM polarisation component added to the initial TM loss associated with the TM polarisation component so that the total losses are the same for both polarisation components.

In a further, non-illustrated embodiment of the invention also constituting an integrated polarisation dependent loss (PDL) compensator, a reflecting surface is arranged to reflect the polarisation components outputted by the two waveguides towards a photodiode which is aligned to detect maximum output power and so as to minimise PDL. In this case the photodiode provides an electrical output signal indicative of the detected optical power but does not itself couple the optical signal for onward transmission along an output fibre or waveguide. The reflecting surface, which may be dispensed with in an alternative embodiment, reflects the light transmitted from the output end of each waveguide through an angle, for example 90°, outwardly of the sheet in FIG. 1 and towards the active area of the photodiode. However the photodiode is deliberately misaligned relative to the reflected beams so as to balance the amounts of the two polarisation components, for example the TE and TM modes, received in order to minimise the PDL and, as a result, some light of one polarisation mode, for example the TM mode, passes to one side of the active area and is lost, whereas substantially all the light of the other polarisation mode reaches the photodiode.

Various modifications of the above described arrangement are possible within the scope of the invention. For example one of the EVOA's may be dispensed with. Furthermore, instead of the different losses applied to the two polarisation components being provided by attenuators, such differential losses may be applied by differential coupling, for example by positioning the ends of the output conductors from a splitter relative to the input conductors to a combiner in order to introduce differential PDL losses. Alternatively, the attenuators may be replaced by gain elements such that the different losses are compensated for by different gains applied by such elements.

Generally such a device could be used to provide a variable ratio of TE/TM polarisation components in a waveguide by varying the relative powers of the two polarisation components before recombining them. Such a device would have many applications in a coherent polarisation modulation based system, for example as a polarisation switch. The device would allow for the complete control of the state of polarisation in an integrated optical circuit (since there are generally only two states present). Alternatively the device could serve to totally extinguish one of the polarisation components in which case the device would serve as a polariser producing light having only one of the polarisation components. Such a device can be produced to have a high extinction ratio with a low loss for the remaining polarisation component.

Furthermore the device may be incorporated in a polarisation switch or active wavelength router or in a polarisation diversity receiver, or may be applied to demultiplex/multiplex cross-polarised channels in an optical communication system.

1. A polarisation beam splitter/combiner comprising a substrate (5), two waveguides (2, 3; 10, 11) formed on the substrate (5) for conducting two different polarisation components, and an evanescent coupler (6; 12, 13) acting between the waveguides (2, 3; 10, 11) to split apart or combine together the two polarisation components conducted along the waveguides (2, 3; 10, 11), wherein the evanescent coupler (6; 12, 13) comprises substantially identical adjacent portions of the two waveguides (2, 3; 10, 11) arranged symmetrically with respect to one another and having geometries such that one of the polarisation components extends laterally within each waveguide portion to a greater extent than the other polarisation component and the coupling length for one of the polarisation components is an even multiple of the coupling length for the other polarisation component, so that substantially complete splitting apart or combining together of the two polarisation components occurs due to the resulting difference between the coupling length for said one polarisation component and the coupling length for said other polarisation component.

2. A polarisation beam splitter/combiner according to claim 1, wherein the coupling length for one of the polarisation components is twice the coupling length for the other polarisation component.

3. A polarisation beam splitter/combiner according to claim 1, wherein the length of the evanescent coupler (6; 12, 13) is an integral multiple of the shorter of the two coupling lengths.

4. A polarisation beam splitter/combiner according to claim 1, wherein neither of the waveguides (2, 3; 10, 11) incorporates metal cladding in the vicinity of the evanescent coupler (6; 12, 13).

5. A polarisation beam splitter/combiner according to claim 1, which is integrated with an optical circuit.

6. A polarisation beam splitter/combiner according to claim 1, which is incorporated in a polarisation switch or active wavelength router.

7. A polarisation beam splitter/combiner according to claim 1, which is incorporated in a polarisation diversity receiver.

8. A polarisation beam splitter/combiner according to claim 1, wherein one of the waveguides (2, 3; 10, 11) incorporates a polarisation rotator for transforming the polarisation of one of the polarisation components to the polarisation of the other polarisation component prior to the two components being combined.

9. A polarisation beam splitter/combiner according to claim 1, which is applied to demultiplex/multiplex cross-polarised channels in an optical communication system.

10. A polarisation beam splitter/combiner according to claim 1, wherein photodetector means are aligned in relation to the waveguides to receive different proportions of the two polarisation components from the waveguides and to produce an electrical output signal indicative of the optical power of the optical signal and substantially independent of the polarisation of the optical signal.

11. A polarisation beam splitter/combiner according to claim 10, wherein reflecting means are provided for reflecting the polarisation components from the waveguides towards the photodetector means.

12. A polarisation dependent loss (PDL) compensator comprising a polarisation beam splitter for splitting an optical input signal into two polarisation components in two waveguides (2, 3; 10, 11), and photodetector means aligned in relation to the waveguides to receive different proportions of the two polarisation components from the waveguides and to produce an electrical output signal indicative of the optical power of the input signal and substantially independent of the polarisation of the input signal.

13. A polarisation controller comprising a polarisation beam splitter for splitting an input optical signal into two polarisation components in two waveguides (2, 3; 10, 11), means (14, 15) for applying different losses to the two polarisation components, and a polarisation beam combiner (13) for combining together the two polarisation components to produce an output signal incorporating the polarisation components or one of the polarisation components at the required power.

14. A polarisation controller according to claim 13, wherein the splitter and/or combiner comprise a substrate (5), two waveguides (2, 3; 10, 11) formed on the substrate (5) for conducting different polarisation components, and an evanescent coupler (6; 12, 13) acting between the waveguides (2, 3; 10, 11) to split apart or combine together polarisation components conducted along the waveguides, the evanescent coupler (6; 12, 13) comprising substantially identical adjacent portions of the two waveguides (2, 3; 10, 11) arranged symmetrically with respect to one another and having geometries such that one of the polarisation components extends laterally within each waveguide portion to a greater extent than the other polarisation component so that splitting apart or combining together of the two polarisation components occurs due to the resulting difference between the coupling length for said one polarisation component and the coupling length for said other polarisation component.

15. A polarisation controller according to claim 13, which serves as a polarisation dependent loss compensator, for compensating the losses associated with first and second polarisation components of an input signal from a transmission system, wherein the means (14, 15) for applying different losses is arranged to apply a first loss to the first polarisation component and a second loss to the second polarisation component such that the sum of the first loss and the loss for the first polarisation component from the transmission system is substantially the same as the sum of the second loss and the loss for the second polarisation component from the transmission system.

16. A method of splitting apart or combining together two polarisation components comprising passing the polarisation components through two waveguides (2, 3; 10, 11) linked by an evanescent coupler (6; 12, 13), the evanescent coupler (6; 12, 13) comprising substantially identical adjacent portions of the two waveguides (2, 3; 10, 11) arranged symmetrically with respect to one another and having geometries such that one of the polarisation components extends laterally within each waveguide portion to a greater extent than the other polarisation component so that splitting apart or combining together of the two polarisation components occurs due to the resulting difference between the coupling length for said one polarisation component and the coupling length for said other polarisation component.
